(19) United States
(12) Patent Application Publication
(10) Pub. No.: US 2014/0055049 A1
(43) Pub. Date: Feb. 27, 2014

(54) ILLUMINATING DEVICE

(71) Applicant: PHOSTEK, INC., Hsinchu City (TW)

(72) Inventors: Shih-Feng Shao, New Taipei City (TW); Yuan-Hsiao Chang, Taipei City (TW); Shih Tsun Yang, Hsinchu County (TW)

(73) Assignee: Phostek, Inc., Hsinchu City (TW)

(21) Appl. No.: 13/862,216

(22) Filed: Apr. 12, 2013

Related U.S. Application Data
(60) Provisional application No. 61/692,123, filed on Aug. 22, 2012.

(51) Int. Cl. H05B 33/08

(52) U.S. Cl. CPC H05B 33/0806
USPC 315/192; 315/294; 315/185 R

(57) ABSTRACT

An illuminating device includes at least one light-emitting source. The light-emitting source includes a substrate; at least one light-emitting chip disposed on the substrate; and at least one constant-current component electrically coupled to the light-emitting chip. The light-emitting chip includes multiple light-emitting units that are electrically coupled in series, in parallel, or in series-parallel; a first-type electrode, disposed on at least one of the light-emitting units, for electrically coupling to a central DC power source; a second-type electrode disposed on at least one light-emitting unit different from the one, on which the first-type electrode is disposed; and a tapped point configured for electrically coupling at least one of the light-emitting units to the constant-current component.

### BACKGROUND OF THE INVENTION

1. Field of the Invention

The disclosure generally relates to an illuminating device, and more particularly to a light-emitting diode (LED) illuminating device.

2. Description of Related Art

Light-emitting diodes (LEDs) have been widely applied for illumination purposes as their luminous efficiency is greatly enhanced and cost/price is considerably reduced. LEDs have, in theory, a lifetime over seventy thousand hours. However, a driving circuit adapted for high-power LED illumination applications (e.g., LED street lamps) normally has a lifetime less than ten thousand hours, therefore substantially affecting reliability or increasing maintenance cost of the LED lamps. One of the reasons is that an electrolytic capacitor (e.g., aluminum electrolytic capacitor) should be used at an output end of the driving circuit to reduce output ripple so that flicking phenomena is blocked. The lifetime of the aluminum electrolytic capacitor is substantively related to its ambient temperature, that is, the higher the ambient temperature is, the shorter the lifetime becomes.

A need has thus arisen to propose a novel illuminating device to improve conventional LED illuminating lamps.

### SUMMARY OF THE INVENTION

In view of the foregoing, it is an object of the embodiment of the present invention to provide an illuminating device in absence of an electrolytic capacitor; in a package with enhanced usage convenience; or with a tapped point with enhanced overall efficiency.

According to one embodiment, an illuminating device includes at least one light-emitting source. The light-emitting source includes a substrate, at least one light-emitting chip, and at least one constant-current component. The light-emitting chip is disposed on the substrate, and the constant-current component is electrically coupled to the light-emitting chip. Specifically, the light-emitting chip includes a plurality of light-emitting units, a first-type electrode, a second-type electrode, and at least one tapped point. The light-emitting units are electrically coupled in series, in parallel, or in series-parallel. The first-type electrode is disposed on at least one of the light-emitting units, and is configured for electrically coupling to a central direct-current (DC) power source. The second-type electrode is disposed on at least one light-emitting unit different from the light-emitting unit on which the first-type electrode is disposed. The tapped point is configured for electrically coupling at least one of the light-emitting units to the constant-current component.

According to another embodiment, an illuminating device includes at least one light-emitting source. The light-emitting source includes a substrate, at least one constant-current component, and a plurality of light-emitting chips. The light-emitting chips are disposed on the substrate, and are electrically coupled in series, in parallel, or in series-parallel. The light-emitting source also includes a first-type electrode, a second-type electrode, and a tapped point. The first-type electrode is disposed on at least one of the light-emitting chips, and is configured for electrically coupling to a central direct-current (DC) power source. The second-type electrode is disposed on at least one light-emitting chip different from the light-emitting chip on which the first-type electrode is disposed. The tapped point is disposed on at least one of the light-emitting chips or disposed between two adjacent light-emitting chips, and is configured for electrically coupling to the constant-current component.

### BRIEF DESCRIPTION OF THE DRAWINGS

FIG. 1A shows a block diagram illustrative of an illuminating device according to a first embodiment of the present invention;

FIG. 1B shows a cross sectional view of the light bulb of FIG. 1A;

FIG. 1C shows a cross sectional view of the light-emitting chip of FIG. 1B;

FIG. 1D shows a top view of the light-emitting chip of FIG. 1B;

FIG. 1E shows a top view of the light-emitting source of FIG. 1B;

FIG. 1F shows a circuit diagram of the central DC power source, the light-emitting chip and the constant-current component;

FIG. 2A shows a block diagram illustrative of an illuminating device according to a second embodiment of the present invention;

FIG. 2B shows a cross sectional view of the light-emitting module of FIG. 2A;

FIG. 3A to FIG. 3G show cross sectional views of some exemplary wavelength conversion components; and

FIG. 4A to FIG. 4C show modified structures of the constant-current component.

### DETAILED DESCRIPTION OF THE INVENTION

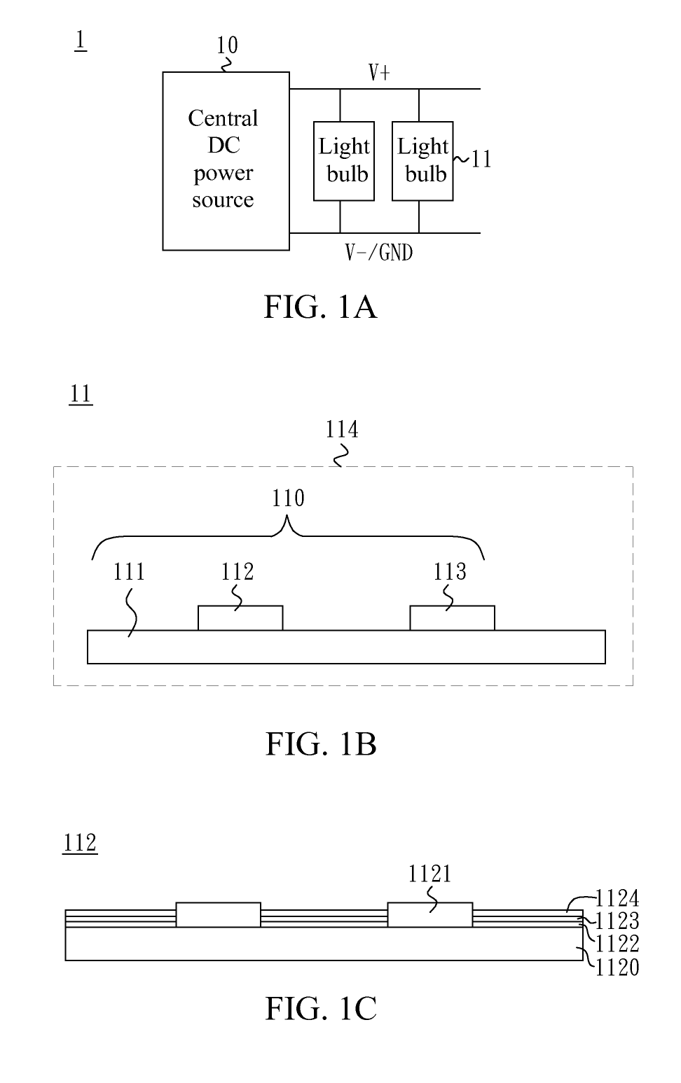

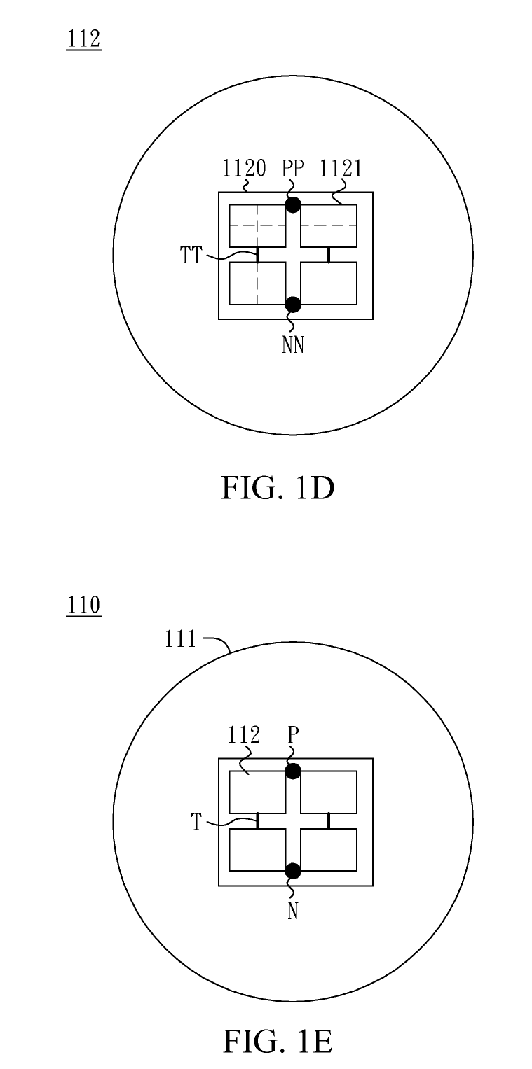

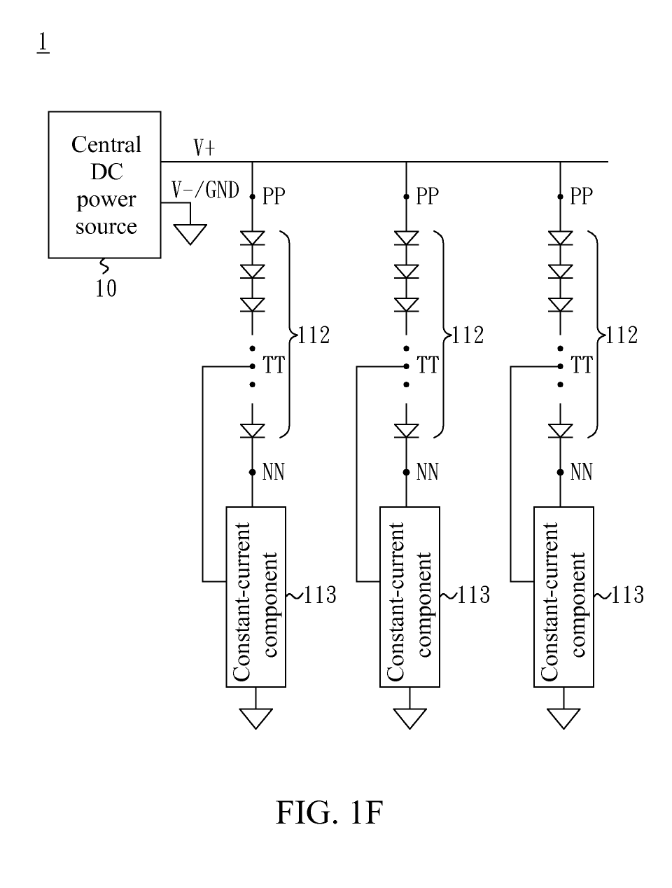

FIG. 1A shows a block diagram illustrative of an illuminating device 1 according to a first embodiment of the present invention. In the embodiment, the illuminating device 1 may include at least one light bulb 11 connected in parallel. The light bulb 11 may, for example, be a candle light. The illuminating device 1 may also include a central direct-current (DC) power source 10, having a first power terminal V+ and a second power terminal V− (or ground terminal GND), configured to provide DC voltage to the at least one light bulb 11. The DC voltage provided by the central DC power source 10 is substantially stable (having tolerable variation of ±10%, and preferably ±5%) such that each light bulb 11 may operate at its preferred condition with little power consumption and high reliability.

A DC power system may commonly provide DC voltages of 12V, 24V, 48V, 110V, 220V, and/or 380V, with respect to different transmission distances, in consideration of better LED operation and lower circuit deterioration. The DC voltages mentioned above may be adjusted in a proper range.

The central DC power source 10 may provide stable DC voltage to LED chips. However, a constant-current component may be utilized at the same time to prevent degradation of light output due to overcurrent caused by increased ambient temperature. FIG. 1B shows a cross sectional view of the light bulb 11 of FIG. 1A. In the embodiment, the light bulb 11 may include a light-emitting source 110, which may include a substrate 111; at least one light-emitting chip (e.g., LED chip) 112 disposed on the substrate 111; and at least one constant-current component 113 (which may be in an integrated circuit form) disposed on the substrate 111 and electrically coupled to the light-emitting chip 112. Specifically, the light-emitting chip 112 may be a packaged chip or a bare chip; and the constant-current component 113 may be a packaged component or a bare component. Moreover, the light bulb 11 may also include a housing 114 that encloses the light-emitting source 110. When the constant-current component 113 is electrically coupled to the central DC power source 10, a constant current may be obtained within the tolerable variation of the DC voltage provided by the central DC power source 10. The constant-current component 113 may be a digital or analog component, such as a constant-current driving integrated circuit, a constant-current regulated diode, or resistor.

FIG. 1C shows a cross sectional view of the light-emitting chip 112 of FIG. 1B, and FIG. 1D shows a top view of the light-emitting chip 112 of FIG. 1B. The light-emitting chip 112 of the embodiment may include an interconnected array. Specifically, the light-emitting chip 112 may include multiple light-emitting units 1121 disposed on a substrate 1120. The light-emitting units 1121 may be electrically coupled, for example, via metal lines, in series, in parallel, or in series-parallel. As shown in FIG. 1C, a first dielectric layer 1122 (e.g., comprised of polymer) is filled between adjacent light-emitting units 1121, and is disposed on the substrate 1120. A second dielectric layer 1123 (e.g., comprised of silicon dioxide) is filled between adjacent light-emitting units 1121, and is disposed on the first dielectric layer 1122. An interconnect 1124 (e.g., comprised of metal) is formed on the second dielectric layer 1123, and is configured to couple the adjacent light-emitting units 1121. Accordingly, a monolithic chip array may be resulted to greatly reduce overall volume. In an alternative embodiment (not shown), a dielectric layer (e.g., comprised of polymer, silicon dioxide or other material) is filled between adjacent light-emitting units 1121, and is disposed on the substrate 1120. An interconnect 1124 (e.g., comprised of metal) is formed on the dielectric layer, and is configured to couple the adjacent light-emitting units 1121. Furthermore, light-emitting units 1121 connected in series may result in a high-voltage LED. As the high-voltage LED may be driven by a current substantially less than an ordinary (or low-voltage) LED with the same power, and dissipated heat is in proportion to the square of driving current, the high-voltage LED therefore dissipates less heat than the ordinary (or low-voltage) LED.

As shown in FIG. 1D, the light-emitting chip 112 may also include a first-type electrode PP (e.g., a positive-type electrode) configured to electrically couple to the central DC power source 10. The first-type electrode PP may be disposed on at least one of the light-emitting units 1121. For example, as shown in FIG. 1D, the first-type electrode PP is disposed between two adjacent light-emitting units 1121. Similarly, the light-emitting chip 112 may also include a second-type electrode NN (e.g., a negative-type electrode) configured to electrically couple to the constant-current component 113. The second-type electrode NN may be disposed on at least one light-emitting unit 1121 different from the light-emitting unit 1121 on which the first-type electrode PP is disposed. For example, as shown in FIG. 1D, the second-type electrode NN is disposed between two adjacent light-emitting units 1121.

According to one aspect of the embodiment, as shown in FIG. 1D, the light-emitting chip 112 may include a tapped point TT configured to electrically couple at least one light-emitting unit 1121 to the constant-current component 113. Accordingly, in addition to the first-type electrode PP and the second-type electrode NN, the light-emitting chip 112 may further include the tapped point TT as a third-type electrode. The tapped point TT may be disposed on at least one light-emitting unit 1121 different from the light-emitting unit 1121 on which the first-type electrode PP or the second-type electrode NN is disposed; or alternatively, the tapped point TT may be disposed on the substrate 1120, and disposed between two adjacent light-emitting units 1121 and electrically coupled to at least one of the two adjacent light-emitting units 1121. Although the tapped point TT shown in FIG. 1D is disposed inside the light-emitting chip 112, the tapped point TT may be disposed on the substrate 111 outside the light-emitting chip 112 instead. As exemplified in FIG. 1F illustrative of a circuit diagram of the central DC power source 10, the light-emitting chip 112 and the constant-current component 113, the second-type electrode NN is electrically coupled to the constant-current component 113 at a node different from another node at which the tapped point TT is electrically coupled to the constant-current component 113.

In one embodiment, the tapped point TT may be disposed between 1/25 to ⅖ of the series-connected light-emitting units 1121. According to series or parallel connection of the light-emitting units 1121 of a light-emitting chip 112, overall operating efficiency may be enhanced by adjusting the position of the tapped point TT within the light-emitting chip 112. For example, with use of the tapped point TT, a constant-current component 113 with a target voltage of 24V may be activated at 21.6V, and may maintain a constant current until 26.4V.

As exemplified in FIG. 1E illustrative of a top view of the light-emitting source 110 of FIG. 1B, the light-emitting source 110 may include a substrate 111, and multiple (say, four) light-emitting chips (e.g., LED chips) 112 disposed on the substrate 111. The light-emitting chips 112 may be electrically coupled, for example, via metal lines, in series, in parallel, or in series-parallel, to facilitate adapting to different input voltage and/or luminous flux (in a unit of lumen) requirements. The light-emitting chip 112 need not adopt a mesa process, but may be a large-size chip package or an independent chip package.

The light-emitting source 110 may also include a first-type electrode P, a second-type electrode N and a tapped point T. The first-type electrode P may be configured to electrically couple at least one of the light-emitting chips 112 to the central DC power source 10, wherein the first-type electrode P may be disposed on at least one of the light-emitting chips 112. The second-type electrode N may be disposed on at least one light-emitting chip 112 different from another light-emitting chip 112 on which the first-type electrode P is disposed. The tapped point T may be disposed on at least one of the light-emitting chips 112, or alternatively, may be disposed between two adjacent light-emitting chips 112, such that the tapped point T may be configured to electrically couple to the constant-current component 113. In one embodiment, the second-type electrode N may be electrically coupled to the constant-current component 113 at a node different from another node at which the tapped point T is electrically coupled to the constant-current component 113. In one example, an 18V blue light-emitting chip 112 is electrically coupled to a 3V red light-emitting chip 112 in series, and a tapped point T is disposed on the substrate 111 and between the blue and red light-emitting chips 112, therefore generating white light.

According to the embodiments discussed above, within the tolerable variation of the DC voltage provided by the central DC power source 10, as the light-emitting sources 110 or the light bulbs 11 are electrically coupled in parallel between the first power terminal V+ and the second power terminal V− (or ground terminal GND), no electrolytic capacitor is required in the light-emitting sources 110 or the light bulbs 11, and no additional driving circuit is required between the light bulbs 11 and the central DC power source 10. As a result, the illuminating device 10 may lengthen its lifetime.

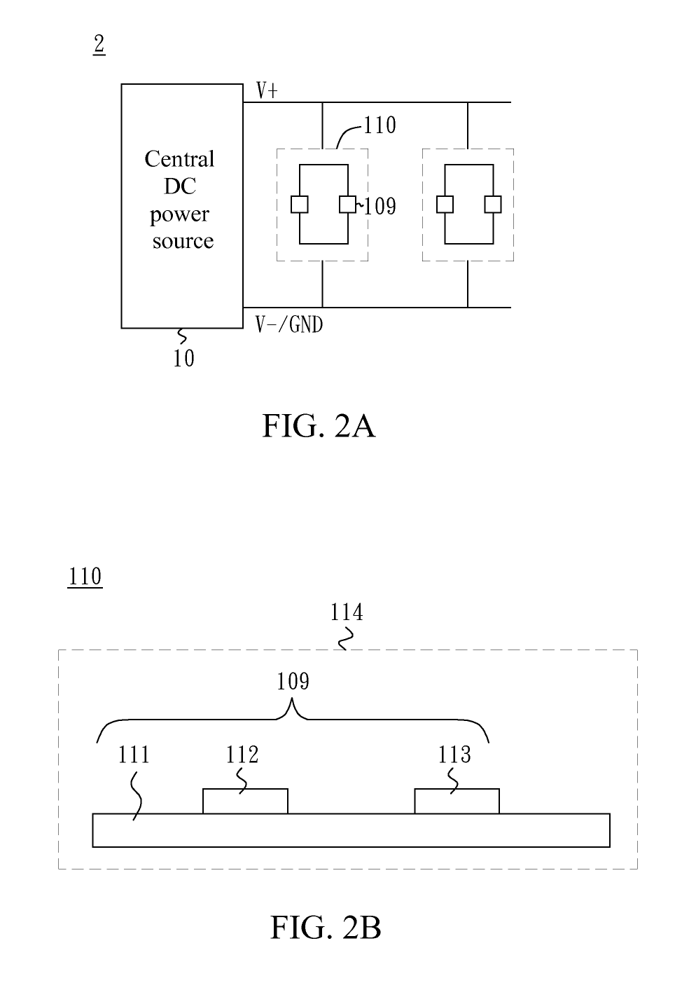

FIG. 2A shows a block diagram illustrative of an illuminating device 2 according to a second embodiment of the present invention. Same numerals are used for elements that are pertained to both the first and the second embodiments. In the embodiment, the illuminating device 2 may include at least one light-emitting source 110 connected in parallel. The central direct-current (DC) power source 10 has a first power terminal V+ and a second power terminal V− (or ground terminal GND), configured to provide DC voltage to the at least one light-emitting source 110. As shown in FIG. 2A, each light-emitting source 110 may include at least one light-emitting module (e.g., comprised of LEDs) 109 connected in parallel. FIG. 2B shows a cross sectional view of the light-emitting module 109 of FIG. 2A. In the embodiment, the light-emitting module 109 may include a substrate 111; at least one light-emitting chip 112 disposed on the substrate 111; and at least one constant-current component 113 disposed on the substrate 111 and electrically coupled to the light-emitting chip 112. Moreover, the light-emitting source 110 may also include a housing 114 that encloses the light-emitting module 109. The light-emitting module 109 of the embodiment may be a package, which enhances convenience in use. Take candle light as an example, one package or three packages may be placed in a candle light. As the packages are connected in parallel, and the candle lights are connected in parallel, a variety of arrangements may therefore be adapted to the central DC power source 10.

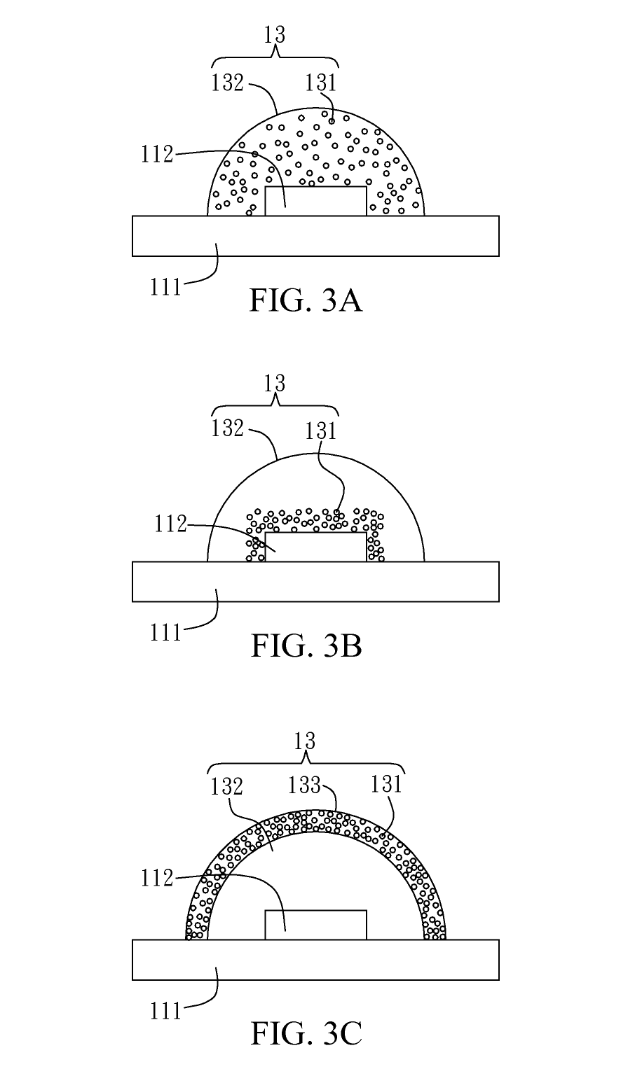

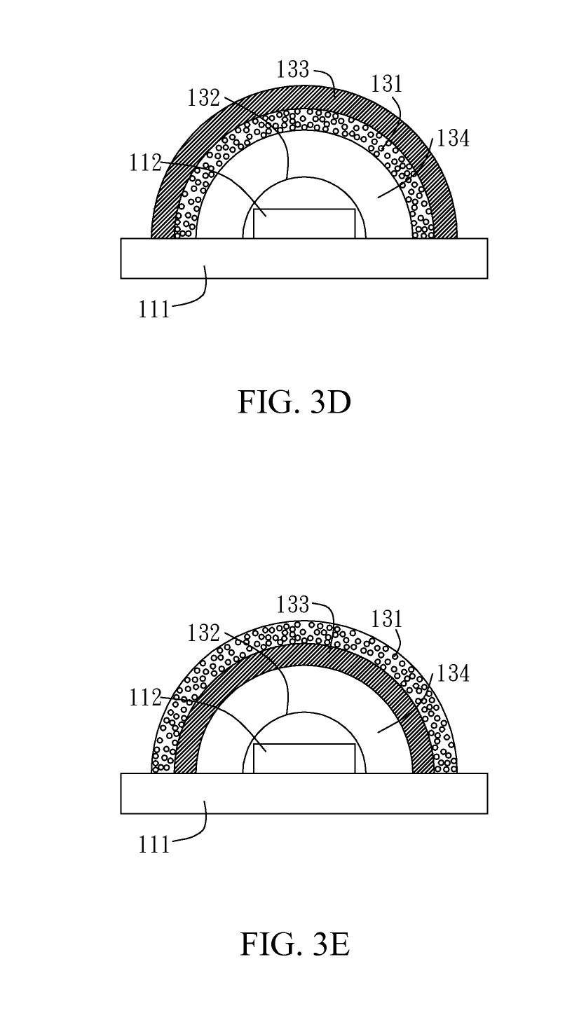

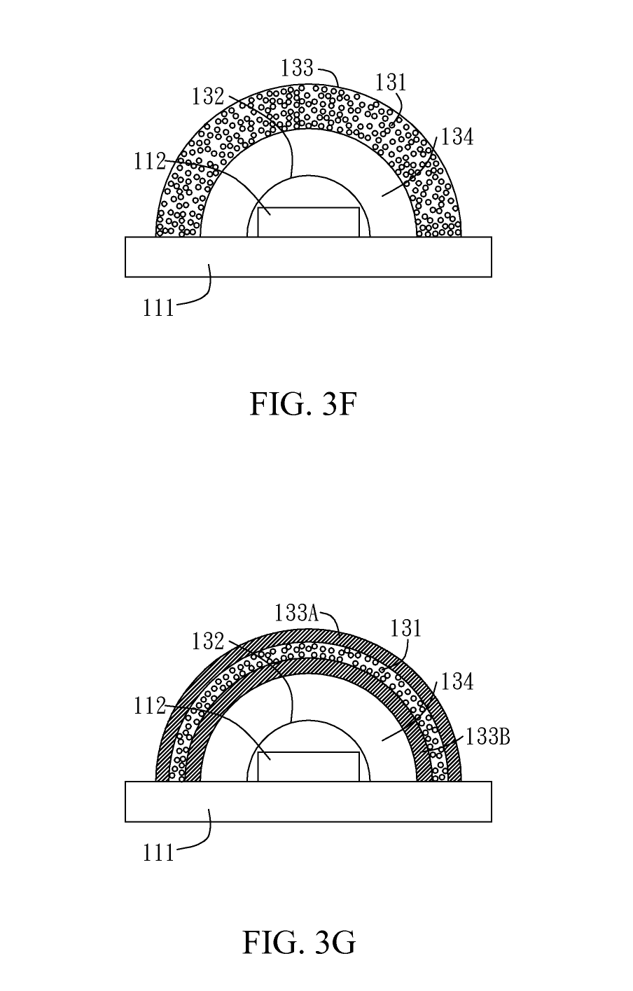

The light-emitting module 109 of the embodiment may be covered with a wavelength conversion component 13, which may be secured to the substrate 111, and may be configured to convert the wavelength of the light-emitting chip 112, for example, to white light. In some embodiments, the wavelength conversion component 13 may cover only the light-emitting chip 112. In other embodiments, the wavelength conversion component 13 may cover both the light-emitting chip 112 and the constant-current component 113. FIG. 3A to FIG. 3C show cross sectional views of some exemplary wavelength conversion components 13. As shown in FIG. 3A, luminescent particles (e.g., fluorescent powder) 131 are evenly distributed inside encapsulating material (e.g., comprised of polymer) 132. The luminescent particles 131 and the encapsulating material together form the wavelength conversion component 13. As shown in FIG. 3B, luminescent particles 131 are conformally distributed on an outer surface of the light-emitting chip 112, and encapsulating material 132 encloses the luminescent particles 131. As shown in FIG. 3C, encapsulating material 132 encloses the light-emitting chip 112, a cover 133 is disposed on the encapsulating material 132, and luminescent particles 131 are remotely distributed in the cover 133. In some embodiments, the cover 133 is made by mixing the luminescent particles 131 and the encapsulating material 132. The cover 133 may be made of epoxy resin, silicone, polymer, ceramic, or their combination. The cover 133 may be made of a material the same as or different from the encapsulating material 132. The luminescent particles 131, the encapsulating material 132 and the cover 133 together form the wavelength conversion component 13.

FIG. 3D to FIG. 3G show cross sectional views of further exemplary wavelength conversion components 13. As shown in FIG. 3D, encapsulating material 132 encloses the light-emitting chip 112, luminescent particles 131 are disposed on an inner surface of a cover 133, and an air gap 134 exists between the encapsulating material 132 and the luminescent particles 131. As shown in FIG. 3E, encapsulating material 132 encloses the light-emitting chip 112, luminescent particles 131 are disposed on an outer surface of a cover 133, and an air gap 134 exists between the cover 133 and the luminescent particles 131. As shown in FIG. 3F, encapsulating material 132 encloses the light-emitting chip 112, luminescent particles 131 are distributed in a cover 133, and an air gap 134 exists between the cover 133 and the encapsulating material 132. In some embodiments, the cover 133 may be made by mixing the luminescent particles 131 and the encapsulating material 132. As shown in FIG. 3G, encapsulating material 132 encloses the light-emitting chip 112, luminescent particles 131 are distributed between an outer cover 133A and an inner cover 133B, and an air gap 134 exists between the inner cover 133B and the encapsulating material 132.

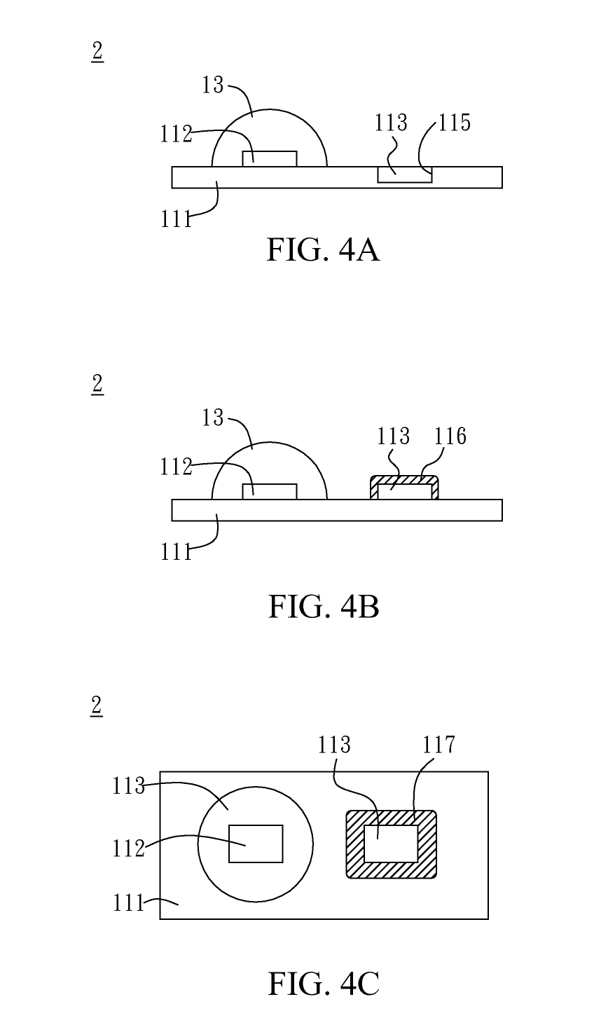

In the embodiment, as shown in a cross sectional view of FIG. 4A, the substrate 111 has a groove 115 configured to accommodate the constant-current component 113. Accordingly, the constant-current component 113 will not block the light output of the light-emitting chip 112. As shown in a cross sectional view of FIG. 4B, a reflective layer (e.g., white silicone) 116 is coated on a surface of the constant-current component 113 to reflect the light output of the light-emitting chip 112. As shown in a top view of FIG. 4C, a reflective ring (e.g., a thin film made of reflective material) 117 is formed around a boundary of the constant-current component 113 to reflect the light output of the light-emitting chip 112.

Although specific embodiments have been illustrated and described, it will be appreciated by those skilled in the art that various modifications may be made without departing from the scope of the present invention, which is intended to be limited solely by the appended claims.

What is claimed is:

1. An illuminating device, comprising at least one light-emitting source, the light-emitting source comprising:
a substrate;
at least one light-emitting chip disposed on the substrate; and
at least one constant-current component electrically coupled to the light-emitting chip;
wherein the light-emitting chip comprises:
a plurality of light-emitting units electrically coupled in series, in parallel, or in series-parallel;
a first-type electrode, disposed on at least one of the light-emitting units, for electrically coupling to a central direct-current (DC) power source;
a second-type electrode, disposed on at least one light-emitting unit different from the light-emitting unit on which the first-type electrode is disposed; and
at least one tapped point configured for electrically coupling at least one of the light-emitting units to the constant-current component.

2. The illuminating device of claim 1, wherein the second-type electrode is configured for electrically coupling to the constant-current component.

3. The illuminating device of claim 2, wherein the second-type electrode is electrically coupled to the constant-current component at a node different from another node at which the tapped point is electrically coupled to the constant-current component.

4. The illuminating device of claim 1, wherein the tapped point is disposed on the light-emitting unit, or is disposed between the light-emitting units.

5. The illuminating device of claim 1, comprising a plurality of the light-emitting sources connected in parallel.

6. The illuminating device of claim 1, further comprising a wavelength conversion component covering the light-emitting chip.

7. The illuminating device of claim 1, wherein the substrate has a groove configured to accommodate the constant-current component.

8. The illuminating device of claim 1, further comprising a reflective layer coated on a surface of the constant-current component.

9. The illuminating device of claim 1, further comprising a reflective ring formed around a boundary of the constant-current component.

10. An illuminating device, comprising at least one light-emitting source, the light-emitting source comprising:
a substrate;
at least one constant-current component;
a plurality of light-emitting chips disposed on the substrate, the light-emitting chips electrically coupled in series, in parallel, or in series-parallel;
a first-type electrode, disposed on at least one of the light-emitting chips, for electrically coupling to a central direct-current (DC) power source;
a second-type electrode, disposed on at least one light-emitting chip different from the light-emitting chip on which the first-type electrode is disposed; and
a tapped point, disposed on at least one of the light-emitting chips or disposed between two adjacent light-emitting chips, for electrically coupling to the constant-current component.

11. The illuminating device of claim 10, wherein the second-type electrode is configured for electrically coupling to the constant-current component.

12. The illuminating device of claim 11, wherein the second-type electrode is electrically coupled to the constant-current component at a node different from another node at which the tapped point is electrically coupled to the constant-current component.
